(19) United States
(12) Patent Application Publication
(10) Pub. No.: US 2025/0146930 A1
(43) Pub. Date: May 8, 2025

(54) TRACER INTEGRATED SMART MATERIALS

(71) Applicant: Damorphe, INC, Houston, TX (US)

(72) Inventors: Indranil Roy, Missouri City, TX (US); Ting Chen, Missouri City, TX (US); Kamel Ben Naceur, Paris (FR); Hifzi Ardic, Houston, TX (US)

(73) Assignee: Damorphe, INC, Houston, TX (US)

(21) Appl. No.: 18/501,712

(22) Filed: Nov. 3, 2023

(51) Int. Cl. G01N 21/31; G01N 21/17; G01N 21/3563

(52) U.S. Cl. CPC G01N 21/31; G01N 21/3563; G01N 2021/1746; G01N 2021/1793

(57) ABSTRACT

Tracer materials that are identifiable in a fluid using electromagnetic signals are integrated into a host material that can be machined into a tool for use in a wellbore. The host material can be dissolvable and designed to dissolve at a certain rate and under certain environmental conditions in the wellbore. As the host material dissolves the tracer material is released into the wellbore where it is measured. Methods of integrating the tracer material and host dissolvable material together are also disclosed.

### CROSS-REFERENCE TO RELATED APPLICATIONS

This application claims priority to U.S. Provisional Patent Application No. 63/422,260 entitled “Shaped Charges with Tracers” filed on Nov. 3, 2022 which is incorporated herein by reference in its entirety.

### BACKGROUND

Tracers are small particles or fluids that are identifiable using electromagnetic signals or other sensing equipment. Tracers have many potential applications and are useful in many ways. In the energy industry, some applications for tracers are for sensing and characterization. However, there are challenges to using tracers. Currently some of the drawbacks are uncertainties relating to deployment and recovery. Also, analysis of tracers, quantities, and placement can be resource-intensive and time-consuming. There are problems with tracers that need solutions.

### SUMMARY

Embodiments of the present disclosure are directed to a tracer system including a signal emitter configured to emit a signal, and a tracer material having a known response to the electromechanical signal. The tracer material is integrated into a host material. The signal emitter is configured to emit the electromechanical signal to a mix of the host material and the tracer material. The tracer system also includes a sensor configured to monitor the mix of host material and tracer material, the sensor being sensitive to the known response. The sensor is configured to identify the presence and a quantity of tracer material within the host material.

Further embodiments of the present disclosure are directed to a method for manufacturing a dissolvable tool having tracer material integrated therein. The method includes providing a host dissolvable alloy in powder form, providing a tracer material in powder form, and mixing the host alloy and tracer material together into a mixture having a tap density of between 25% and 90%. The method also includes consolidating the mixture to produce a green compact and sintering the green compact to achieve a bulk density between 60% and 100% of theoretical density of a designed matrix at a temperature between 100 degrees C. for a duration of between 15 minutes and three hours.

Further embodiments of the present disclosure are directed to a tool for a wellbore including a host dissolvable material and a tracer material integrated into the host dissolvable material to form a composite solid shape, the tracer material being responsive to an electromagnetic signal such that the tracer material is detectable upon release from the host dissolvable material by emitting the electromagnetic signal onto the tracer material. The composite solid shape has a tracer/host ratio defined as a weight percentage of the tracer material and host dissolvable material. The host dissolvable material dissolves in an environment within the wellbore at a predetermined dissolution rate in terms of mass per unit time. The tracer material is released by the host dissolvable material into the environment at a tracer release rate in terms of mass per unit time. A release rate ratio is defined as a ratio of the tracer release rate and the dissolution rate. The release rate ratio is proportional to the tracer/host weight ratio.

### BRIEF DESCRIPTION OF THE FIGURES

FIG. 1 is a FIG. 1 is a schematic illustration of a method for integrating tracers into a material according to embodiments of the present disclosure.

FIG. 2 illustrates a tool 120 made of a tracer-enhanced material according to embodiments of the present disclosure.

FIG. 3 shows a tracer solution 130 according to embodiments of the present disclosure.

FIG. 4 is a focused ion beam (FIB) lift from bi-layered nanocomposite (CRn-C) sample 140 according to embodiments of the present disclosure.

FIG. 5 is a photomicrograph of an interface between crystalline REO tracer particulates 150 according to embodiments of the present disclosure.

FIG. 6 illustrates a strain-induced partially vitrified boundary 152 according to embodiments of the present disclosure.

FIG. 7 illustrates a vial 160 containing a tracer fluid 162 according to embodiments of the present disclosure.

FIG. 8 is an illustration of a tool 170 made of tracer-enhanced material according to embodiments of the present disclosure.

FIG. 9 is an illustration of a tool 180 made of tracer-enhanced material according to the present disclosure.

FIG. 10 shows a tool 180 having dissolvable tracer-enhanced material according to embodiments of the present disclosure.

FIG. 11 is a plot of D10 Tracer taggant emission intensity vs. after-glow decay response (microseconds) according to embodiments of the present disclosure.

FIG. 12 is a depiction of a process 190 for Inert Gas Atomization of powders according to embodiments of the present disclosure.

FIG. 13 is a pre-tailored wet grinding mill 192 according to embodiments of the present disclosure.

FIG. 14 depicts a microstructure of an IGA Powder according to embodiments of the present disclosure.

FIG. 15 shows the powder after cryo-milling (SPD) according to embodiments of the present disclosure.

FIG. 16 shows microstructure post consolidation via various routes SPS where average grain size is approximately 100 nm according to embodiments of the present disclosure.

FIG. 17 shows the microstructure after a HIP process where average grain size is approximately 400 nm according to embodiments of the present disclosure.

### DETAILED DESCRIPTION

Below is a detailed description according to various embodiments of the present disclosure. The present disclosure is directed to methods for design and manufacturing of materials including tracers, and to the use of dissolvable materials which can have tracers integrated into the dissolvable material. As the dissolvable material dissolves, tracers within the material are released into the environment and can be monitored to provide valuable information. With effective placement, tracers are able to yield information regarding fluid flow through a reservoir, information regarding breakthrough times from injectors to producers, and information used to estimate the inter-well oil saturation.

There are at least four categories of tracers: conservative, radioactive, partitioning, and nanoparticle. Conservative tracers are chemical indicators used for evaluating the media in which the tracers are deployed.

Radioactive tracers are like conservative tracers but are radioactive. The radioactivity allows flexibility in detection and measurement in ways that other tracers are unable to achieve.

Partitioning tracers interact with the oil or the aqueous phase and it allows, with the use of a conservative tracer, the calculation of potential oil in place and remaining oil saturation or flowback analysis including water break through.

Nanoparticle tracers, encompassing “quantum dots embedded on nanoparticles have interesting characteristics. For one, they are more environmentally friendly and economical. Nanoparticles can also be applied to assess how multiple tracers move through a reservoir and its application becomes exceedingly valuable for laminated rock and are also important in low permeability zones for example such as shales and sorted sandstone formations. Some nanoparticle tracers may be rare-earth doped oxide, sulfide and halide nanocrystals that emit unique infrared and visible fingerprints when illuminated by very specific laser sources.

Chemical tracers have specific uses and applications, but in some cases naturally occurring chemical tracers, or particles that have similar chemical characteristics to the chemical tracers, can cloud the reading and analysis of recovered fluids. There are a wide range of available tracers and their use in oil, water, or gas is dependent on the size and character of the reservoir in which they are placed. Conducting a tracer test can provide important information regarding the subsurface and can guide the choice of which tracer or tracers to be used.

Tracers and dissolvable materials have an interesting relationship, in that tracers can be integrated into a material that is designed to dissolve in a certain environment under certain conditions, and as the material dissolves the tracers are released into the environment. There are many potential applications for this, including but not limited to providing information relating to the dissolution of the dissolvable material itself. The presence of tracers in flowback fluid from a well informs the operator that the tool in the well is dissolving.

Some of the potential applications in the energy industry include balls for packers to isolate zones, rings deployed anywhere in a wellbore or proppants to be blended with conventional particulates and injected in the formation, or as a trigger for sleeve on the OD of a liner or a ring on the outside of open hole completions with sand screens and/or perforated liners, and Geothermal applications.

For biomedical applications, they can be integrated in microchips to be embedded at a desired site through invasive surgery programmed to subsequently react with bio-fluids and control release the nanocrystals, to be detected as in-vitro diagnostics (IVD) or using other medical and life sciences imaging. These tracers released from degradable bio-compatible alloys may address a wide breadth of bioassays including one or more of Molecular Diagnostics Immunoassay, Cell and Tissue Microscopy, Flow Cytometry.

In some embodiments the tracers can be uniformly distributed throughout the dissolvable material, and in other embodiments the tracers are located in a non-uniform manner. For example, suppose a dissolvable material having no tracers integrated therein prevents the tracer-enhanced material from contacting the environment until such time as the dissolvable material has dissolved sufficiently and the tracers are released into the flowback fluid. In other embodiments two or more varieties of tracers can be used within the dissolvable material and can indicate the dissolution of two or more tracer-enhanced dissolvable materials. There are myriad ways for tracers can be used in conjunction with dissolvable materials.

Some nanoparticle tracers are nanocrystals that may manifest unique emission and absorption spectra and have engineered decay times based on their optical, physical, magnetic, radioactive, and luminescent properties. These tracers can be programmed and designed to a tailored crystallite size, wherein their identification in parts per billion (ppb) can be made for custom spectroscopic and optical detector systems.

There are many methods by which tracers are integrated into a material. In some embodiments, tracers in a powder form are added to a metal or alloy powder blend that serves as the matrix mix. The mix can then be consolidated to produce a green compact. In powder metallurgy, green compacting is the process of pressurizing and cooling metal powder to form a dense, homogeneous solid mass. The tap density of the green compact can be between 25% and 90%. The green compact is then sintered or used as-is to densify the part fully. The consolidation can be performed using cold isostatic pressing (CIP), hot isostatic pressing (HIP), spark plasma sintering (SPS), a vacuum hot press (VHP) or powder injection molding (PIM). A sintering process can be performed using SPS or another sintering process. In some embodiments an Argon or equivalent heavy inert gas is contained in the powder mix.

The sintering process can be at a temperature between 100 degrees C. and 1,250 degrees C. The sintering process can be performed for a duration of between 15 minutes to 3 hours. In some embodiments the thickness of the green compact determines, at least in part, the duration of the sintering process. In some embodiments the duration is 15 minutes per centimeter thickness of the part. So, a part that has a dimension of 2 centimeters thick needs 30 minutes of duration.

Another consideration are the thermal and pressure limits of the tracer material and the host material. The tracer material may have a temperature above which the tracer material loses the desired characteristics it needs, so the sintering process can be performed at a temperature below the that temperature. The tracer material may melt above that temperature or may otherwise lose the desired characteristics. Then the manufacturer can cold or warm-work the material to a near net shape or perform other machining procedures.

In other embodiments the tracers can be integrated into a material by powder injection molding followed by low temperature sintering. A binder with an outgassing temperature below a sintering temperature can ensure success of consolidating the materials together, and the survivability of the tracer material in the dissolvable bulk.

Still other methods can be used including additive manufacturing using laser and powder bed or other techniques enabling the production of complex parts for a variety of applications.

In some embodiments the tracers are liquid and are accommodated (adsorbed or absorbed) in a dissolvable alloy matrix of a controlled porosity and permeability which may be coated with a barrier or a membrane having controlled release through Fickian diffusion. The volume of tracer adsorbed or absorbed is an order of magnitude or more (20-25%) more than that laced on activated carbon (2-3%).

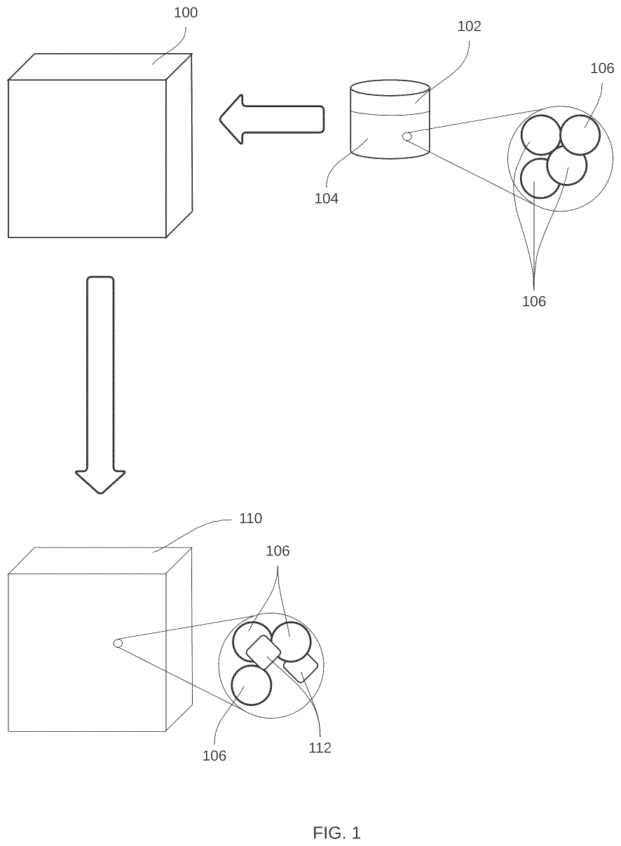

FIG. 1 is a schematic illustration of a method for integrating tracers into a material according to embodiments of the present disclosure. A pretracer material 100 can be a solid metal billet, a powder, a liquid, or any other suitable form of material that is to be integrated with tracers. A vial 102 including tracers 104 is added to the pretracer material 100 in one or more of the many routes disclosed herein. The tracer material 104 may be a fluid or a particulate comprised of many small tracer particles 106. The particles are very small, some as small as a nanometer in diameter.

The pretracer material 100 is the host material. It can begin in powder form, billet form, or another suitable form according to the manufacturing route appropriate for a given application. Once the host material and tracer material are properly integrated together, the combined material can be formed into a tool for use in a wellbore for an oil and gas operation. The host material can be a dissolvable material that dissolves under certain conditions and at a certain dissolution rate in the wellbore. As the material dissolves, it releases the tracer material into the surrounding area where the tracer material can be detected. The presence and quantity of the tracer material in the wellbore is indicative of the dissolution of the tool.

By combining the pretracer material 100 with the tracer material 104, the result is a tracer-enhanced material 110. An enlarged view of the tracer-enhanced material 110 shows a combination of the tracer particles 106 and the pretracer material particles 112. The schematic depictions of the tracer particles 106 and the pretracer material particles 112 is for purposes of illustration and are not necessarily to scale and do not necessarily represent a shape of the tracer particles 106 or the pretracer material particles 112.

The pretracer material 100 can be a dissolvable material that can be formed into a tool for use in an oil well. The tool will be placed in a known environment that may feature one or more of oil, water, hydrocarbons, sand, etc. As the tracer-enhanced material 110 dissolves, the tracer particles 106 are released into the environment for detection and measuring.

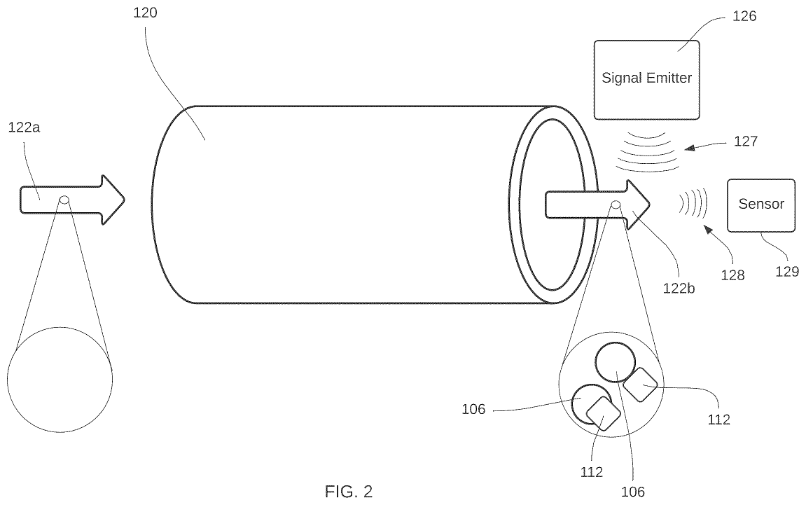

FIG. 2 illustrates a tool 120 made of a tracer-enhanced material according to embodiments of the present disclosure. The tool 120 in this embodiment is a simple pipe experiencing pre-flow 122a moving from the left-hand side to post-flow 122b exiting the tool 120. The fluid in the pre-flow 122a does not include any tracer material, but the post-flow 122b includes some tracer material that may include tracer particles 106, a tracer fluid (in the case of a fluid tracer material) and some pretracer material particles 112 that have dissolved and reached the fluid which then flows back to a measuring device that monitors for the presence and quantity of the tracer particles 106 in the fluid.

The tool 120 can be used with a tracer detection system according to the present disclosure that can monitor for the presence of tracer material within the post-flow 122b. The tracer detection system can include an electromechanical signal emitter 126 that emits an electromechanical signal 127 that reaches the post-flow 122b. The tracer materials within the post-flow 122b are designed to respond to the signal 127 with a known response. The known response can be an electromagnetic signal 129 from the tracer material. The known response can be light at a certain known wavelength. The known response can be sound waves at a predetermined known frequency.

The tracer detection system can also include a sensor 129 that is attuned to monitor for the known response from the tracer material in the post-flow 122b. The sensor 129 can be an optical sensor, an acoustic sensor, a radioactive sensor, a geiger counter, an inductively coupled plasma mass spectrometry (ICP-MS) sensor, an X-ray sensor, a chemical sensor, or any other suitable type of sensor according to the configuration of the tracer material and the known response that results from the signal 127 being directed at the post-flow 122b and the tracer materials within. In some embodiments the sensor 129 is part of a sampling observation procedure in which a sample of fluid containing the tracer materials which are observed using lab equipment which may include optical sensors, chemical sensors, etc. In some embodiments the signal emitter 126 and the sensor 129 are constructed into a single device.

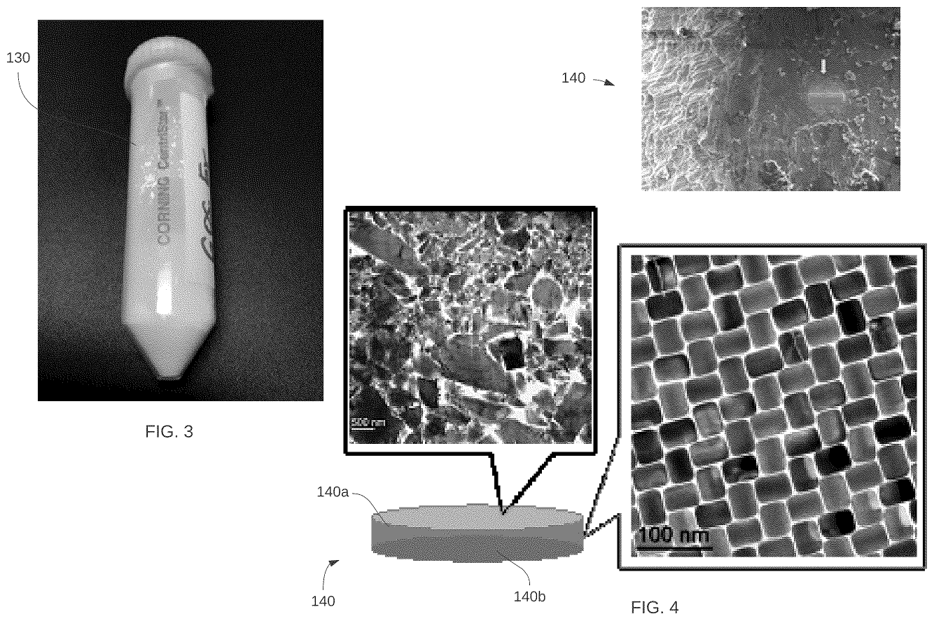

FIG. 3 shows a tracer solution 130 according to embodiments of the present disclosure. The tracer solution 130 is a nanoparticulate rare earth oxide(s) (REO) with a Gadolinium base including its other variants as tracers with a unique signature. The tracers have been successfully integrated in the bulk of a nanocrystalline high entropy alloys (HEA) including one or more components being one or more bulk metallic glasses (BMG) or nanocrystalline composite dissolvable alloys. These nanoparticle tracers are released as the dissolvable material dissolves and are then delivered back to the surface with flowback fluids which are sampled at the surface.

FIG. 4 is a focused ion beam (FIB) lift from bi-layered nanocomposite (CRn-C) sample 140 according to embodiments of the present disclosure. The sample 140 includes a top CRn-C ultra-hard layer 140a and a REO diffusion bonded layer 140b according to embodiments of the present disclosure. FIG. 4 illustrates the FIB lifts for each.

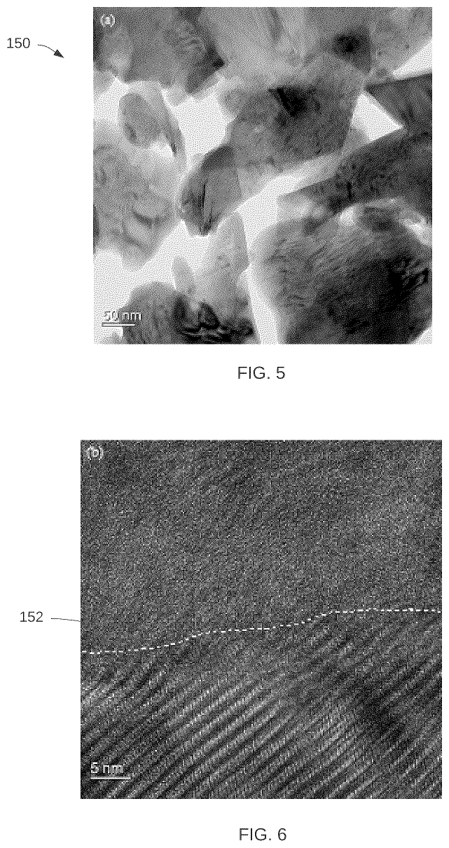

FIG. 5 is a photomicrograph of an interface between crystalline REO tracer particulates 150 according to embodiments of the present disclosure.

FIG. 6 illustrates a strain-induced partially vitrified boundary 152 according to embodiments of the present disclosure. The boundary 152 is formed during consolidation.

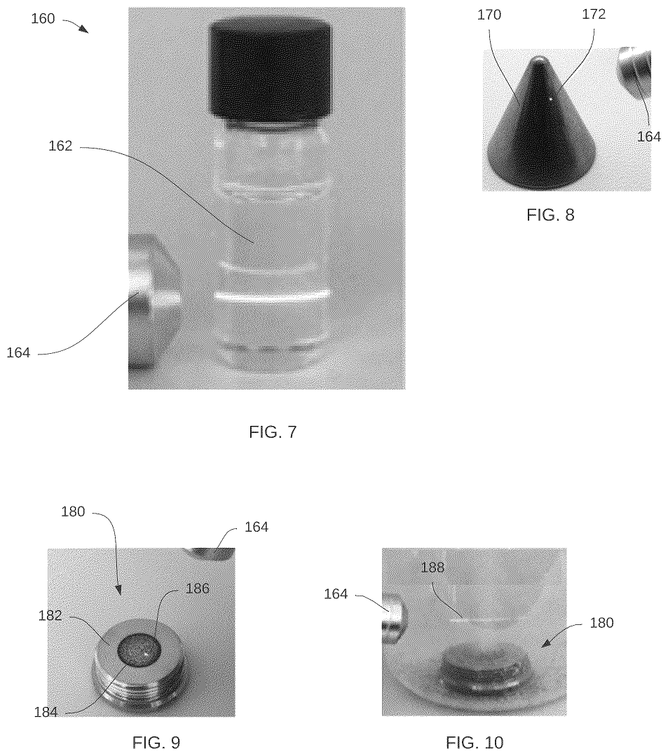

FIG. 7 illustrates a vial 160 containing a tracer fluid 162 according to embodiments of the present disclosure. The tracer fluid 162 is illuminated by a collimated light source 164 to show the tracers within the fluid 162. The tracers in the depicted embodiment are Nano-crystalline REO tracers of tailored shapes, sizes, and electronic structures. The tracers are observed to emit unique photonic fingerprints in the visible spectrum when illuminated by collimated light sources 164 of predetermined wavelengths are integrated in the meta-materials as tracers. The tracers can be tailored to emit photonic decays in the ultraviolet and infrared spectrum, allowing the design of unique variants and number of tracing products. These tracers exhibit unique absorption spectra and engineered decay-times based on their optical, physical, luminescence and other properties. These tracers are identifiable in parts-per-billion dilution by custom designed spectroscopic and optical detectors (in-flow detector in development). These tracers are biocompatible and can be embedded within the human body safely.

FIG. 8 is an illustration of a tool 170 made of tracer-enhanced material according to embodiments of the present disclosure. The tool 170 is a shaped charge. A collimated light source 164 is trained on the tool 170, and the tracers within the tracer-enhanced material is visible as a bright dot 172 on the tool 170.

FIG. 9 is an illustration of a tool 180 made of tracer-enhanced material according to the present disclosure. The tool 180 includes a nozzle 182 and a plug 184 within the nozzle. The plug 184 is made of tracer-enhanced material, but the nozzle 182 is not. A collimated light source 164 is trained on the plug 184 and the tracers within the tracer-enhanced material is visible as a dot 186.

FIG. 10 shows a tool 180 having dissolvable tracer-enhanced material according to embodiments of the present disclosure. The tool 180 is in an environment in which the dissolvable tracer-enhanced material is dissolving. The fluid of the environment is saturated with tracer particles that become visible when a collimated light source 164 is directed through the fluid. A visible line 188 is formed as the light passes through the fluid and strikes the tracer particles and refracts.

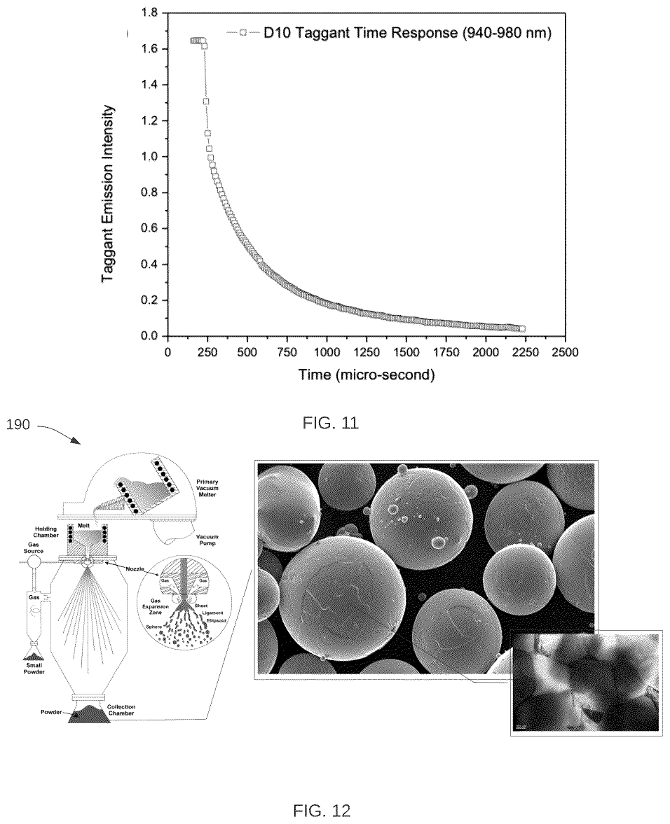

FIG. 11 is a plot of D10 Tracer taggant emission intensity vs. after-glow decay response (microseconds) according to embodiments of the present disclosure.

FIG. 12 is a depiction of a process 190 for Inert Gas Atomization of powders according to embodiments of the present disclosure. Many materials from the periodic table can be used as the input in designing a stable matrix for reactive material with integrated nanocrystals as tracers.

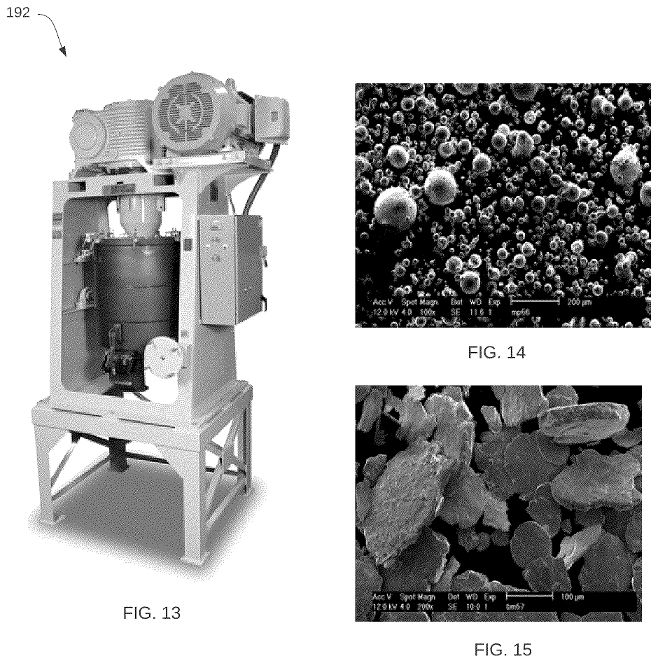

FIG. 13 is a pre-tailored wet grinding mill 192 according to embodiments of the present disclosure. The mill 192 can SPD IGA powders into particulates having nanocrystalline grains. Consolidating these via CIP and sinter or HIP, SPS or VHP among other routes produces a nanocrystalline bulk solid having ultra-high strength via Hall Petch Strengthening and other unique properties.

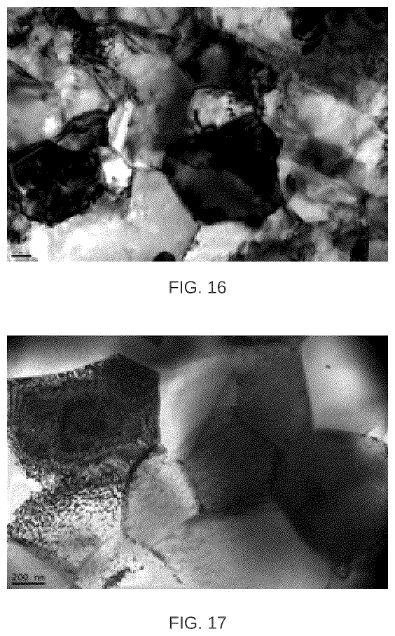

FIG. 14 depicts a microstructure of an IGA Powder according to embodiments of the present disclosure. FIG. 15 shows the powder after cryo-milling (SPD) according to embodiments of the present disclosure. FIG. 16 shows microstructure post consolidation via various routes SPS where average grain size is approximately 100 nm according to embodiments of the present disclosure. FIG. 17 shows the microstructure after a HIP process where average grain size is approximately 400 nm according to embodiments of the present disclosure.

According to the present disclosure there are many tracer materials and tracer material compositions that have many different characteristics and are identifiable using a variety of different detection methods. The tracer materials and dissolvable materials disclosed herein can be formed into tools having a variety of purposes in a wellbore. The tracers may be soluble in a variety of different fluids such as water, brine, oil, gas, or a combination of any of the foregoing.

According to embodiments the tracer material is uniquely identifiable and can be made of nano-particulates or crystals in raw or finished forms, in solid, powder or liquid states for integration in the material. The tracer material may also be chemicals of unique character, doped or functionalized nanocrystals, natural or synthetic radioactive materials in varying forms, quantum dots on a silicon or other substrate, an electronic sensor. The sensor may be passive without battery powered by RFID or another signal has a battery, piezo, another signal, electromechanical signal will release some signal that is trackable, optical, RF, any trigger, chemical trigger, laser, thermal, pressure, passive Bluetooth. The sensor may be active and have a battery that may be a chemical, circular, different form factors, spherical, blade, solid state, lithium ion, can also be powered by energy harvesting, kinetic, thermal, vibrational, flow, pressure, etc.

The tracer material may also be doped rare-earth oxide, sulfide and halide nanocrystals that emit unique infrared, UV and visible fingerprints when illuminated by very specific collimated sources e.g., laser. The tracer material can be programmed and designed to tailored crystallite size, wherein their identification in parts per billion (ppb) can be made by custom spectroscopic and optical detector systems. The tracer material may manifest unique emission and absorption spectra and engineered decay times based on their optical, physical, magnetic, radioactive, luminescent among other properties. The tracers may also be nano-particulate tracers that are released under control to indicate material loss, distinct special location, transport path, success of a designed trigger, etc. The tracer material may also be water and oil soluble. The tracer material can also be present in solution as colloidal or suspended particulates and is flowable when released from the bulk material.

The tracer-enhanced material may be an alloy designed for structural parts encompassing light metal with a specific gravity (SG) between 1 and 3.5. In other embodiments the tracer-enhanced material may be a metal with SG between 3.5 and 9. The tracer-enhanced material can also be a heavy metal with a SG between 9 and 15. The tracer-enhanced material can also be an alloy having a strength between 25 ksi and 250 ksi. The strength may be augmented via severe plastic deformation processes of cryogenic milling ultrafine grained powders before consolidation. The strength may also be augmented by an equal channel angular processing of consolidated billets, or by flow-forming, cold-warm, hot forging, extrusion, etc.

In other embodiments the tracer-enhanced material can be a degradable (dissolvable0 alloy with a tailored insensitivity to selected anions for example(s), halides such as Chloride (Cl—); Bromide (Br—) among others or cations for example Aluminum (Al3+), Calcium (Ca2+), Magnesium (Mg2+), Sodium (Na+), Potassium (K+), among others. The degradation of the designed alloy may be initiated when exposed to a fluid (or environment) which are aqueous in nature, brines, hydrocarbons or emulsions (water or oil continuous phase), bio-fluids (human or other animal encompassing, blood, tears, sweat, saliva/sputum, synovial fluid, BAL, ascites fluid, urine, stool, and reproductive fluids and synthetic Hank's solution); industrial wastes; agricultural fluids; among others; or corrosion resistant alloy, unaffected by fluids detailed above.

Embodiments of the present disclosure are also directed to methods to integrate tracers in a host material. The method includes providing a tracer material in powder form and add the powder tracer material to an alloy powder to form a powder blend. The weight (or volume percent) of added tracers can be between 2 and 92%, the remaining being the alloy powder. The method also includes blending the powder alloy and the powder tracer material to mix in a V-blender or equivalent device to produce a homogenous mix having a tap density between 25 and 90%. The method continues by consolidating the blended powder via cold isostatic pressing (CIP), wherein the cold isostatic press pressure varies between 1000 and 60,000 psi to produce a green, preferably a near net compact. The method also includes sintering the green contact to achieve bulk density between 60 and 100% of theoretical density of designed matrix at temperatures between 100 degrees C. and 1,250 degrees C. for a duration of 15 mins to 3 hours based on thickness of sintered part. In some embodiments the duration is a function of thickness, such as holding the duration for 15 minutes at the elevated temperature per centimeter thickness of the part.

The melting temperature of powder blend and thermal stability of the tracer may dictate the sintering temperature and time. Accordingly, in some embodiments the thermal stability and/or melting temperature of the tracer material and powder blend may be used as upper limits for the temperature and duration.

Other embodiments of the present disclosure are directed to other methods to integrate tracers in a host material. In some embodiments the manufacturer consolidate the powders by employing a hot isostatic pressing (HIP) procedure, a vacuum hot pressing (VHP) procedure, a spark plasma sintering (SPS) procedure, a powder injection molding (PIM) process as alternate mechanisms for consolidating powder blend. The powders can be canned in a sealed metallic envelop for HIP and VHP, preferably near net shape, and by so doing achieve a bulk density between 60% and 100% of theoretical density of designed matrix. In other embodiments the powders are consolidated under pressure and temperature in a HIP. In some embodiments Argon or another equivalent heavy inert gas is contained in the powder blend, and the manufacturer can consolidate it under pressure of between 1,000 psi and 60,000 psi at temperatures between 100 degrees C. and 1,250 degrees C., for a duration of 15 mins to 3 hours based on thickness of sintered part. In some embodiments the duration can be approximately 15 minutes at the elevated temperature per centimeter thickness of the part.

In other embodiments the manufacturer consolidates the powders under pressure and temperature by a VHP process at a pressure of between 1,000 psi and 40,000 psi, and at a temperature between 100 degrees C. and 1,250 degrees C. for a duration of 3 to 12 hours.

In other embodiments the manufacturer consolidates the powders under pressure and temperature by a VHP process. The pressure is between 1,000 psi and 45,000 psi SPS at temperatures between 100 degrees C. and 1,250 degrees C. for a duration of 5 mins to 3 hours.

In other embodiments the manufacturer consolidates the powders using a PIM part via sintering at temperatures between 100 degrees C. and 1,250 degrees C. for a duration of 5 mins to 2 hours. In other embodiments the manufacturer can employ a HIP process or a VHP process at a pressure between 1,000 psi and 30,000 psi during consolidation.

In some embodiments the melting temperature of the combined host alloy powder and tracer material powders have a thermal stability and/or melting temperature that limits the temperatures and/or pressures at which these processes can be effectively performed.

Further embodiments of the present disclosure are directed to methods for integrating tracer material into a host material using additive manufacturing processes that employ laser and powder bed or other ingot metallurgical techniques where tracer materials are added to a cooled outgassing and stirred melt after removal of dross to minimize loss of tracer materials through dross. Other embodiments include the use of surface adhering, matrix mixing, impregnating, adsorbing, or absorbing in a permeable and porous structure including separately a scaffold.

The tools shown and described herein throughout and particularly with respect to FIG. 2 can be any application within the energy sector including but not limited to balls for packers to isolate zones; rings deployed anywhere in a wellbore; proppants to be blended with conventional particulates and injected in the formation; as a trigger for a sleeve on the outer diameter of a liner; a ring on the outside of open hole completions with sand screens and/or perforated liners; Geothermal applications, etc. There are a multitude of oil and gas applications where a tool is needed in the wellbore temporarily, after which the tool is intended to dissolve and effectively vanish. Embedded tracer material in such a tool can provide an indication of the success, success rate, success time, or failure of the dissolvable material.

Further embodiments of the present disclosure are directed to biomedical applications encompassing tracer materials integrated into microchips to be embedded at a desired site through invasive surgery programmed to subsequently react with bio-fluids and to release the tracer materials, to be detected as in-vitro diagnostics (IVD) or using other medical and life sciences imaging.

Embodiments of the present disclosure are directed to mechanisms for controlled release of tracer material from a host material or tool and detection of the released tracer materials from the tool. The environment in which the dissolvable material will dissolve can include water, oil in a continuous phase or a stabilized reverse emulsion or other fluids including bio fluids and environmentally friendly fluids.

In some embodiments the dissolvable material is dissolved by erosion, resulting in a controlled release of the tracer material into surrounding fluids when subjected to abrasive conditions (flow, fretting etc.).

In some embodiments the tracer material can be transported via produced fluids, flowback water, produced water, hydrocarbons, or any fluid coming back through the well in oil and gas applications.

Embodiments including tracer materials released from degradable bio-compatible alloys may address a wide breadth of bioassays including one or more of molecular diagnostics immunoassay, cell and tissue microscopy, or flow cytometry.

Detecting the tracer material in the fluids can be performed with an in-flow device with a spectroscopic detector or from a sampled fluid with a such a detector. In some embodiments the tracer material releasing indicates a certain time has elapsed and/or the tracer materials can indicate that material dissolution has reached a critical dimension either by starting or stopping the release of tracer materials. For example, the tool may comprise a ball that blocks maintains pressure above or below the ball. When the ball dissolves to a certain point it will no longer be capable of withstanding the pressure and the fluid will break through the ball. This is an intended effect, and identifying the presence of tracer material in the fluid flow will alert an operator that this has occurred, or when it will occur.

Other objectives of the tool can include an indication that corrosion or erosion may have reached a critical amount, which is a section of a tool, pipe, ball, packer, etc. has reached a critical wear level, damage level, or reduced size. For example, if the tool is rotating equipment such as gears, shafts, wind turbine components, etc. that wear during operation, the release and identification of tracer material in the surrounding fluids helps to abet preventive maintenance and remote inspection without human intervention.

In other embodiments the tool can be designed to have functionalities such as indicating a change in flow or production on a screen that shows when it is producing either by starting or stopping release of tracer materials or a change in flow properties or composition such as releasing a tracer material in water but not in oil or vice versa. This can indicate a water entry, zonal production, etc.

In still further embodiments the tool can indicate the location, nature, and depth of a fracture in a composite material with different tracer materials layered in epoxy coatings. In one example the tool can be a wind turbine blade, and knowing the tracer material has been released helps to schedule maintenance of the blades before a catastrophic failure occurs and without human intervention.

In other embodiments the tool can indicate a trigger timing, that triggering has taken place. For example, the tool may be a “Tracer Rupture Disc,” or a “Tracer Integrated Dissolvable Alloy filled Injection or Production Nozzle for Limited Entry Liner.”

In yet other embodiments the tracer material release can indicate a change of temperature either from flow, gas production (adiabatic) etc.

The foregoing disclosure hereby enables a person of ordinary skill in the art to make and use the disclosed systems without undue experimentation. Certain examples are given to for purposes of explanation and are not given in a limiting manner.

1. A tracer system, comprising:
a signal emitter configured to emit a signal;
a tracer material having a known response to the signal, wherein the tracer material is integrated into a host material, and wherein the signal emitter is configured to emit the signal to a mix of the host material and the tracer material; and
a sensor configured to monitor the mix of host material and tracer material, the sensor being sensitive to the known response, wherein the sensor is configured to identify a presence and a quantity of tracer material within the host material.

2. The tracer system of claim 1 wherein the tracer material comprises nano-particulate material.

3. The tracer system of claim 2 wherein the tracer material is a doped rare-earth oxide.

4. The tracer system of claim 2 wherein the tracer material is a sulfide nanocrystal or a halide nanocrystal, and wherein the signal comprises a collimated light source.

5. The tracer system of claim 2 wherein the tracer material is at least one of a doped rare-earth oxide, a oxy-sulfide, or a halide nanocrystal material.

6. The tracer system of claim 1 wherein the signal is at least one of an optical signal, an electromagnetic signal, an acoustic signal, an infrared signal, an ultraviolet signal, a radioactive signal, a chemical signature signal, X-ray, an ICP-MS, or a visible optical signal.

7. A method for manufacturing a dissolvable tool having tracer material integrated therein, the method comprising:
providing a host alloy in powder form;
providing a tracer material in powder form;
mixing the host alloy and tracer material together into a mixture having a tap density of between 25% and 90%;
consolidating the mixture to produce a green compact; and
sintering the green compact to achieve a bulk density between 60% and 100% of theoretical density of a designed matrix at a temperature between 100 degrees C. and 1,250 degrees C. for a duration of between 15 minutes and three hours.

8. The method of claim 7 wherein consolidating the mixture to produce the green compact comprises at least one of cold isostatic pressing (CIP), hot isostatic pressing (HIP), vacuum hot pressing (VHP), spark plasma sintering (SPS), and powder injection molding (PIM).

9. The method of claim 7 wherein the consolidating to mixture is performed at a pressure between 100 psi and 60,000 psi.

10. The method of claim 7 wherein the duration is a function of a size of the tool, wherein the duration is approximately 15 minutes per centimeter of material of the tool.

11. The method of claim 7 wherein the temperature is below a melting temperature of the tracer materials and of the host alloy.

12. The method of claim 7 wherein the temperature is within a thermally stable range of the tracer material.

13. The method of claim 7 wherein the duration is within a thermally stable range and temperature of the tracer material.

14. The method of claim 7 wherein the consolidating the mixture comprises a vacuum hot pressing (VHP) process at a pressure between 1,000 psi and 40,000 psi at a temperature of between 100 degrees C. and 1,250 degrees C. and wherein the duration is between 3 and 12 hours.

15. The method of claim 7 wherein the consolidating the mixture comprises a vacuum hot pressing (VHP) process at a pressure between 1,000 psi and 45,000 psi is applied to the mixture confined in a sealed container.

16. The method of claim 7 wherein sintering comprises spark plasma sintering (SPS) at a temperature between 100 degrees C. and 1,250 degrees C., and wherein the duration is between 5 minutes and 3 hours.

16. The method of claim 7 wherein consolidating comprises a powder injection molding (PIM) process at a temperature between 100 degrees C. and 1,250 degrees C., and wherein the duration is between 5 minutes and 2 hours.

17. The method of claim 7 wherein consolidating comprises at least one of a hot isostatic pressing (HIP) process and a vacuum hot pressing (VHP) process at a pressure between 1,000 psi and 30,000 psi.

18. The method of claim 7 wherein the host alloy is a dissolvable alloy.

19. A tool, comprising:
a host material;
a tracer material integrated into the host material to form a composite solid shape, the tracer material being responsive to a signal such that the tracer material is detectable upon release from the host material by emitting the signal onto the tracer material, wherein:
the composite solid shape has a tracer/host ratio defined as a weight percentage of the tracer material and host material;
the host material degrades in an environment at a predetermined dissolution rate in terms of mass per unit time;
the tracer material is released by the host material into the environment at a tracer release rate in terms of mass per unit time;
a release rate ratio is defined as a ratio of the tracer release rate and the dissolution rate; and
wherein the release rate ratio is proportional to the tracer/host weight ratio.

20. The tool of claim 19 wherein the environment includes water and wherein the tracer material is water soluble.

21. The tool of claim 19 wherein the environment includes oil and wherein the tracer material is oil soluble.

22. The tool of claim 19 wherein the environment comprises a fluid in a living organism.

23. The tool of claim 19 wherein the environment comprises industrial fluid discharge.

24. The tool of claim 19 wherein the environment comprises an agritech environment.

25. The tool of claim 19 wherein the tracer/weight ratio of between 2% and 90%.

26. The tool of claim 19 wherein the tool has a strength of between 25 ksi and 250 ksi, wherein the strength is augmented via a severe plastic deformation process of cryogenic milling ultrafine grained powders together.

27. The tool of claim 19 wherein the tool has a strength of between 25 ksi and 250 ksi, wherein the strength is augmented via an equal channel angular processing of consolidated billets, the consolidated billets formed by combining the host dissolvable material and the tracer material together as powders.

28. The tool of claim 19 wherein the tool comprises a first component having a first tracer/host weight ratio and a second component having a second tracer/host ratio.

29. The tool of claim 19 wherein the host material is a dissolvable material.
